(19) United States
(12) Patent Application Publication
(10) Pub. No.: US 2018/0123420 A1
(43) Pub. Date: May 3, 2018

(54) ACTUATOR COMPRISING A PLUG HELD IN A CARRIER AND HYBRID MODULE COMPRISING SUCH AN ACTUATOR

(71) Applicant: Schaeffler Technologies AG & Co. KG, Herzogenaurach (DE)

(72) Inventors: Eugen Kombowski, Malsch (DE); Dominik Höll, Bühl (DE)

(73) Assignee: Schaeffler Technologies AG & Co. KG, Herzogenaurach (DE)

(21) Appl. No.: 15/565,647

(22) PCT Filed: Apr. 15, 2016
(86) PCT No.: PCT/DE2016/200171

§ 371 Date: Oct. 10, 2017

(30) Foreign Application Priority Data
Apr. 15, 2015 (DE) 10 2015 206 800.5
Aug. 6, 2015 (DE) 10 2015 214 984.6

(51) Int. Cl. H02K 5/22; H02K 1/12; H02K 7/10; H01R 4/18; H01R 4/30; F16D 27/00

(52) U.S. Cl. CPC H02K 5/225; H02K 1/12; H02K 7/10; F16D 2027/001; H01R 4/30; F16D 27/00; H01R 4/183

(57) ABSTRACT

An actuator for a motor vehicle clutch actuation includes a carrier. The carrier supports at least one stator and one sensor. At least one recess is present in the carrier. A signal transmission and/or power supply element is routed through the recess in order to allow for a signal transmission and/or a power supply to the stator and/or to the sensor. The signal transmission and/or power supply element is integrated into the carrier. An example embodiment includes a hybrid module with a clutch and the actuator and a plug inserted therein.

### CROSS-REFERENCE TO RELATED APPLICATIONS

This application is the United States National Phase of PCT Appln. No. PCT/DE2016/200171 filed Apr. 5, 2016, which claims priority to German Application Nos. 102015206800.5 filed Apr. 5, 2015 and 102015214984.6 filed Aug. 6, 2015, the entire disclosures of which are incorporated by reference herein.

### TECHNICAL FIELD

The present disclosure relates to an actuator for a motor vehicle clutch actuation, including a carrier which supports at least one stator and one sensor. At least one recess is present in the carrier, through which a signal transmission and/or power supply element is routed in order to allow for a signal transmission and/or a power supply to the stator and/or to the sensor. The signal transmission and/or power supply element can also be utilized for contacting a robot or multiple sensors. The actuator can be designed as an electrical central release device.

### BACKGROUND

Clutch engagement and release systems are already known from the prior art, for example from DE 10 2008 033 038 A1. Said publication discloses a clutch release system including a master cylinder and a slave cylinder in a pressure line which connects said cylinders, wherein a quick connector is situated in the line region which is characterized by a one-part safety catch connected to one part of the quick connector.

Hydraulically functioning slave cylinders are frequently utilized, for example as types of CSC devices. Alternatively thereto, mechanical or electrical central release devices are also utilized, however. Such electrical central release devices utilize, for example, brushless motors and spring bands. The spring bands are then wound up and unwound. It is also known to utilize recirculating ball gears in such electrical central release devices. DE 10 2013 225 354 A1, for example, discloses such an electrical central release device. Said publication discloses a clutch device including a counterpressure plate; a pressure plate, which can be displaced in a limited manner in the axial direction, for the frictional clamping of a clutch disk between the pressure plate and the counterpressure plate; a lever element acting on the pressure plate in order to displace the pressure plate in the axial direction; a central flange which is situated at least partially between the pressure plate and the lever element and has at least one leadthrough possibility for the pressure plate and/or the lever element; and a wear adjustment device for the automatic adjustment with respect to clutch wear. The lever element can be brought to rest against the central flange in order to prevent an undesirable adjustment with respect to clutch wear.

Such electrical central release devices are distinguished by a high level of integration and therefore require only limited installation space.

It has been highly complex up to now, however, to supply the electrical central release device with power and to ensure signal transmission. For this purpose, cables are usually routed through an opening in the actuator carrier. The stator, the rotor, and/or the sensors or the sensor are/is connected to one end of the cable, while a conventional plug of the type which is also used at another point in the engine compartment is utilized at the particular other end of the cable. Such plugs are relatively large, however. The connection is also extremely laborious and error-prone.

The problem addressed by the present disclosure is to provide a remedy in this case and to eliminate or at least reduce the disadvantages of the prior art. The problem is considered to be, in particular, that of implementing an electrical connection of the stator (the phases) and the sensor or the sensors in the limited installation space. The common standards for an “automotive plug” are to be complied with. Further restrictions to be taken into consideration are the predetermined minimum radii for lines, which traditionally could not be complied with given the particularly small installation space as is the case with an electrical central release device. Specifically, the lines could not be directly connected to the sensor or to the stator, since the stator, which is at the other end of the line in this case, would either have to be guided through the carrier, for the purpose of which an opening was required that was too large with respect to stiffness, or the plug could only be subsequently installed, which is difficult to accomplish in standard series production, however. A remedy is to be provided in this case as well. Therefore, there is a long-felt need for an enabled plug solution, which is also size-adjusted and can be directly utilized.

### BRIEF SUMMARY

The present disclosure discloses a device of the type in question in that the signal transmission and/or power supply element is integrated into the carrier.

In other words, therefore, a plug is provided, which offers a wall leadthrough and contacting on the opposite side of the wall. An example embodiment according to the present disclosure includes integrating the plug into the electrical central release device or the electrical central release device carrier. The contacting to the sensor and to the stator takes place through the carrier. The plug can therefore be manufactured by the supplier in such a way as to be finally assembled, including lines and a finally crimped plug on the other end of the line. All that is left to do is the insertion into the carrier housing and fixing in position, e.g. by means of screws. The installation of the plug can take place, depending on the installation sequence of the main assembly, either on the electrical central release device as a subassembly, so that this can be delivered as a complete solution including lines, or the insertion of the plug can take place after the installation of the electrical central release device into the main assembly.

Finally, the installability is improved, the need to account for bending radii requirements is eliminated, the design of a strain relief is simplified, an improved seal is made possible/effectuated and, despite the integration, it is made possible to separate the individual components, in particular to separate the signal transmission and/or power supply element from the stator, the rotor and/or the sensor or sensors.

Example embodiments are claimed in the dependent claims and are explained in greater detail in the following.

In some example embodiments, the plug housing is largely countersunk in the carrier, in particular in a carrier rear wall.

Domes of the plug guide the contact elements through the openings in the carrier. On the transmission side, the contacts encounter the contacting in the sensor or in the stator. A sealing takes place either by means of a seal around the domes in the openings in the carrier or, alternatively, a seal can be axially situated between the plug and the carrier rear wall. The seal can be designed and/or placed, for example, as a seal surrounding the plug. Alternatively, the domes can also be situated in the transmission-side elements, such as the sensor and the stator, and so the plug, or the circuit board installed therein, has the contact faces.

The design of the plug, in principle, can be such that said plug includes a housing and a circuit board contained therein, or includes a pressed screen or is formed largely therefrom. The lines are welded and fixed on the circuit board. The circuit board is fixed in the plug housing, for example, by means of screws. The interior of the housing can be subsequently filled with a sealing compound in order to ensure the tightness and the insulation. A standard plug can be located at the other end of the line.

In an example embodiment, the stator has a carrier-side, distal end which is designed for holding or fastening at least one electrical contact element. The electrical contact element can be connected or is connected to a litz wire of a cable. In this way, the electrical contact can be implemented between the contact element and the litz wire, for example, by means of welding or a screw connection.

In an example embodiment, the electrical contact element is designed as a sleeve, a bushing, a clamp, a crimping unit, and/or an overshoe. The connection of the electrical contact element to the litz wire of a cable is simplified as a result.

Furthermore, in an example embodiment, the distal end of the stator has a fork-like or pin-like shape. The connection or the electrical contact between the electrical contact element and the litz wire is simplified as a result.

In this case, the distal end of the stator can be connected or is connected to one litz wire in each case directly or via interconnection of an intermediate piece. A direct connection between the distal end of the stator and the litz wire can be implemented, for example, by means of welding, while the connection via interconnection of an intermediate piece can be implemented, for example, by the use of domes which accommodate plug contacts.

According to one advantageous exemplary embodiment, the distal end of the stator includes a thread on which a nut is placed in such a way that the contact element is supported in a certain position relative to the carrier and/or the stator. The electrical contact between the electrical contact element and the litz wire of a cable is implemented as a type of terminal block, for example, in this case.

When the litz wire is welded, for example, resistance-welded, directly on a tine or two tines or on a pin/prong formed by the distal end of the stator, or a contacting intermediate part, for example forming the contact element, is installed thereon, being fastened, for example, in an interlocking, force-locked and/or bonded manner, for example, by means of resistance welding, a permanent and durable connection is implemented between the distal end of the stator and the litz wire.

In an example embodiment, the signal transmission and/or power supply element is designed as a plug or is integrated therein, on the one hand or, on the other hand, individual contact elements are inserted into the carrier without a plug. The connection/contacting of a power supply device or a signal reception or transmission device to the stator, the sensor/the sensors, and the rotor is facilitated by means of a plug. The plug-free connection reduces the number of required components.

In an example embodiment, the plug includes a housing, within which male and/or female plug contacts are present. One method of installation will be explained and, in particular, a “poka-yoke” installation is made possible.

In order to guarantee an efficient integration, in an example embodiment, the plug includes a housing which is inserted or integrated into the recess of the carrier in an interlocking, force-locked and/or bonded manner, and is retained there.

In an example embodiment, the plug is closed by a cover mounted on the outside thereof. Dirt particles and fluids, such as for example oil or water, are thereby prevented from entering.

In an example embodiment, the cover is utilized as strain relief and may be fastened on the carrier, for example, being screwed thereon. The tensile load on weld seams that are present is reduced and, as a result, the service life of the plug connection is improved.

In an example embodiment, the recess is surrounded by a material-reduction area, preferably completely, which has a thinner wall thickness than the adjoining area of the carrier.

When each plug contact is surrounded by one (separate) dome or multiple plug contacts are surrounded by one (shared) dome, a robust plug design becomes possible.

When the dome or the domes is/are assigned to the actuator or the plug, a long-lasting connection of the elements which are to be connected to the signal transmission and/or power supply element is made possible.

In an example embodiment, the housing is matched/adapted to the recess and is integrated into a wall of the carrier.

In an example embodiment for the application in clutches, the actuator is designed as an electrical central release device.

The present disclosure also relates to a hybrid module including a clutch, however, such as a single clutch or a twin clutch, including an actuator of the type according to the present disclosure and including a plug inserted therein.

Electrical lines, for example, for controlling the stator, the rotor, and/or the sensor/the sensors of the electrical central release device, are provided for the electrical central release device or another actuator and are utilized accordingly. The lines can be connected by means of a plug.

In order to minimize openings through a carrier of the central release device or through a corresponding wall axially in front of the actuator, an example embodiment includes the plug integrated into the wall/the housing/the carrier. The carrier includes, for this purpose, at least one receptacle having a reduced wall thickness. Within this wall area, openings are then provided for the corresponding connections. The connections are provided via domes, and so no lines are necessary on the electrical central release device side. The domes can be assigned to the electrical central release device or the plug. The plug itself includes a housing which is matched to the receptacle in such a way that it can be integrated here.

### BRIEF DESCRIPTION OF THE DRAWINGS

Example embodiments are described in greater detail with the aid of the figures, in which:

FIG. 1 shows a perspective representation of a carrier of an actuator, which is designed as an electrical central release device, according to one first embodiment of the present disclosure, including an integrated plug without a pressed screen and a line or lines,

FIG. 2 shows a perspective representation of the carrier from FIG. 1 from a transmission side, which differs from that shown in FIG. 1, in which the view is from the engine side,

FIG. 3 shows a perspective view of the plug of the actuator from FIGS. 1 and 2, mainly from the transmission side,

FIG. 4 shows the plug housing with indicated pressed screen/indicated circuit board of the plug from FIG. 3,

FIG. 5 shows a perspective representation from the transmission side of a second embodiment of a plug for the plug represented in FIG. 3,

FIG. 6 shows the plug from FIG. 5 including a pressed screen/circuit board which has not yet been inserted,

FIG. 7 shows a longitudinal section of the electrical central release device outside the area of the plug,

FIG. 8 shows a longitudinal section through the plug according to one further embodiment of the present disclosure,

FIG. 9 shows a perspective representation of the plug from the engine side,

FIG. 10 shows a representation of the plug from FIG. 9, which is comparable to that shown in FIG. 9, although without the pressed screen/circuit board,

FIG. 11 shows the pressed screen/circuit board from FIG. 9 for insertion into the housing from FIG. 10,

FIG. 12 shows a perspective representation of the stator of the electrical central release device including connection points,

FIG. 13 shows one further embodiment of the carrier which is comparable to the embodiment from FIG. 1,

FIG. 14 shows a representation of the carrier from FIG. 13 according to the type of representation from FIG. 2, in which the plug has not yet been inserted,

FIG. 15 shows a cutout representation of the carrier from FIG. 14, with the plug inserted,

FIG. 16 shows a cutout representation of the carrier and the plug, including screw-held contacts,

FIG. 17 shows a sectional representation of the carrier from FIG. 16 in the area of the screw-held contacts,

FIG. 18 shows a cutout representation of the carrier without a plug and including welded contacts,

FIG. 19 shows a cutout representation of the carrier including a plug and including welded contacts,

FIG. 20 shows a cutout representation of the carrier, also including welded contacts, and a partially cast plug,

FIG. 21 shows a cutout representation of the carrier having one possible cover design, and

FIG. 22 shows a hybrid module including an electrical central release device of the type according to the present disclosure, and a clutch, into which a plug can be inserted into the electrical central release device.

### DETAILED DESCRIPTION

The Figures are merely schematic in nature and are intended only for enabling an understanding of the present disclosure. Identical elements are provided with the same reference numbers. Features of the individual exemplary embodiments can be interchanged. The corresponding features can therefore be interchanged.

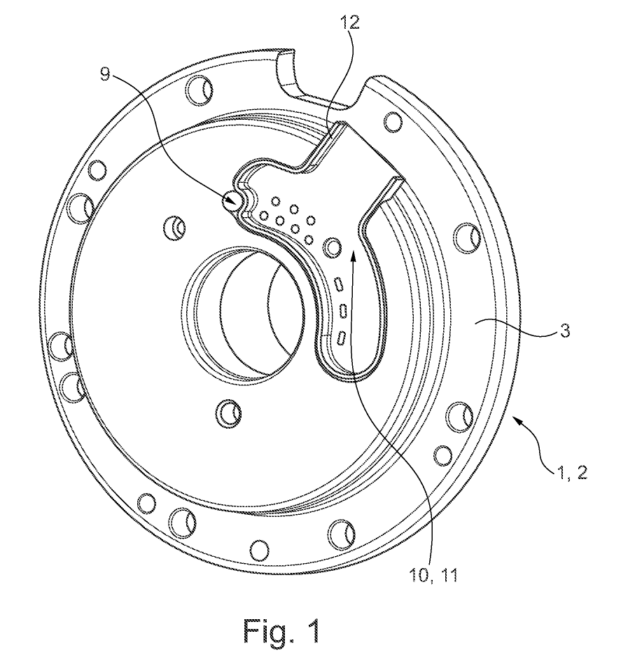

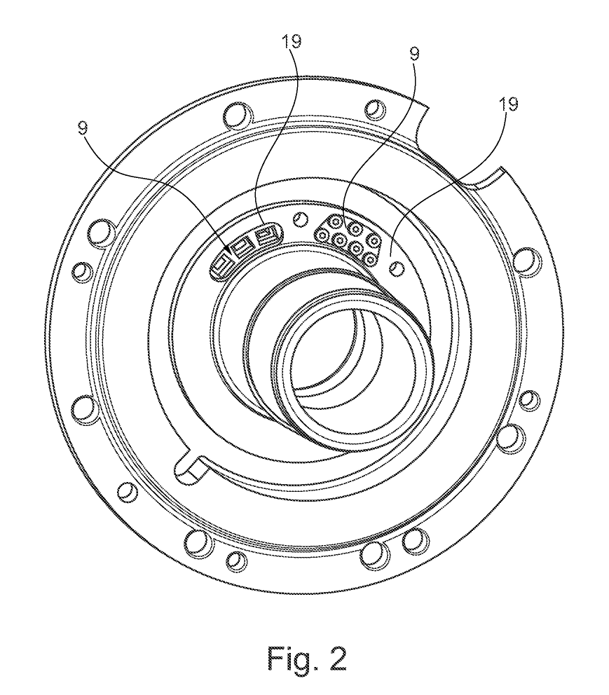

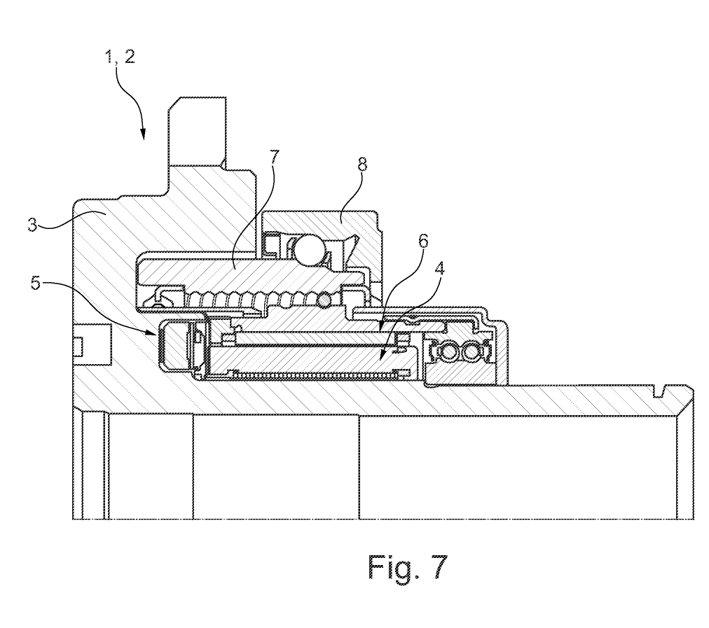

FIGS. 1 and 2 show a carrier 3 of an actuator 1 which is designed as a type of electrical central release device 2. The carrier 3 is made from a steel alloy in order to be sufficiently stiff. The carrier 3 is also represented in FIG. 7, in the longitudinal section, and includes at least one stator 4 and a sensor 5 situated axially adjacent thereto. The stator 4 is situated radially within a rotor 6. If current is supplied to the stator 4, it causes the magnetic rotor 6 to rotate. As a result, a movement of an adjusting sleeve 7 is effectuated, which results in an axial displacement of a support bearing 8. This axial displacement can be utilized for achieving an engagement or disengagement of a clutch, such as a single clutch/twin clutch.

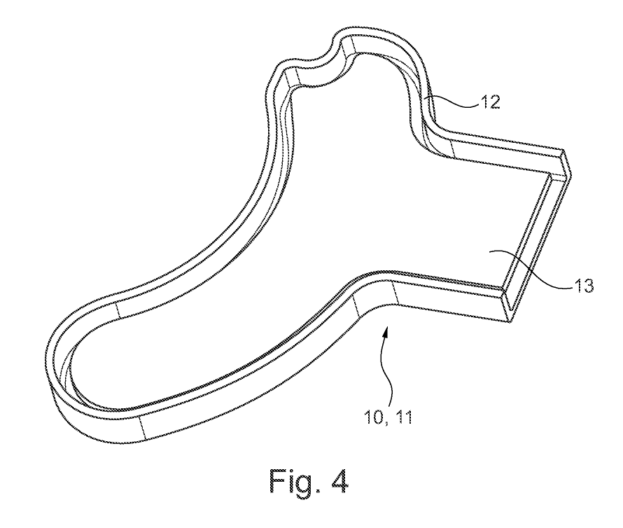

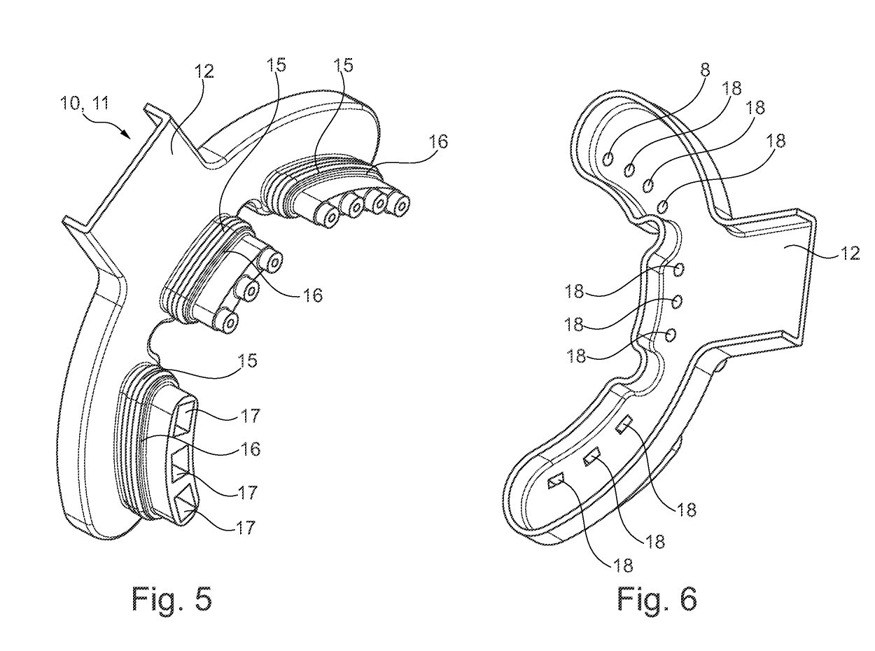

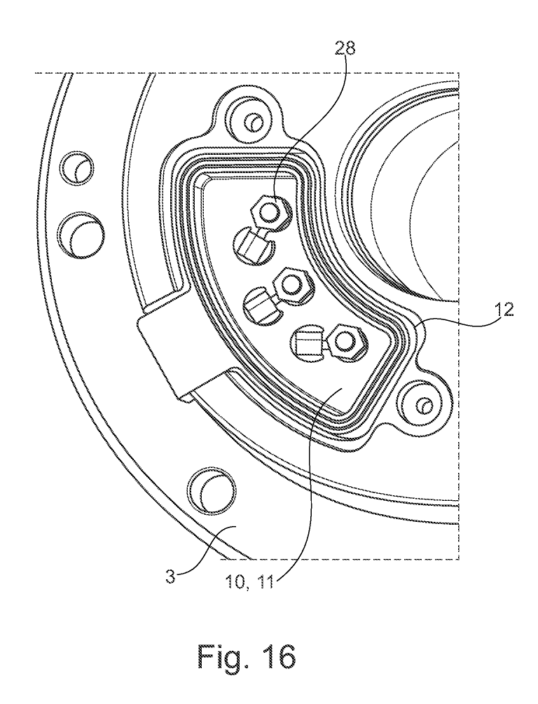

A recess 9 is provided in the carrier 3 in order to be able to supply the stator 4, the sensor 5, and/or the rotor 6 with signals, or to be able to receive signals therefrom, and/or to be able to supply the aforementioned three components with current. A signal transmission and/or power supply element 10 is inserted into the recess 9. The signal transmission and/or power supply element is designed as a plug 11 in this case. The signal transmission and/or power supply element therefore includes a housing 12 of the plug 11, and a pressed screen/circuit board 13 (which is not represented here, however), as well as a line 14 (which is not represented in FIG. 1, either). Reference is made to FIG. 4 with respect to the pressed screen/circuit board 13. Reference is made to FIG. 16 with respect to the line 14.

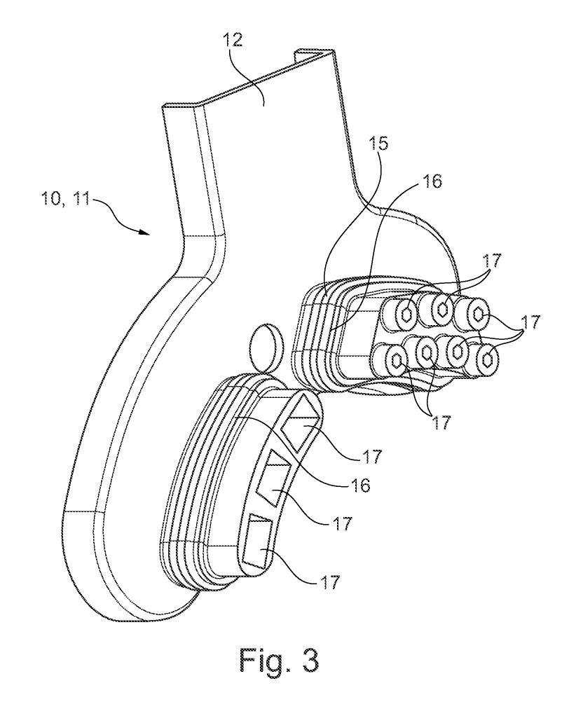

The plug 11 also includes a seal 15 which is represented in FIG. 3. The seal 15 surrounds two domes 16 in this case, which are formed from the material of the housing 12 of the plug 11. The domes 16 are integral components of the housing 12.

Plug contacts 17 are present in the domes 16. While the plug contacts 17 of one dome 16 are designed as female contacts, the plug contacts 17 of the other dome 16 are designed as male plug contacts. The male plug contacts are situated next to each other in the circumferential direction, on the one hand, but, on the other hand, are also radially layered in two arrangements extending in the circumferential direction. As viewed in the radial direction of the electrical central release device 2, the domes 16 are situated radially equally far away with respect to their center. They can also be situated at different distances away from the center.

The housing 12 has an essentially “Y” shape. The housing 12 has a shell shape, in principle, as is clear from FIG. 4. In this case, the pressed screen 13/circuit board 13 is inserted in the interior of the shell shape and is retained in an interlocked and/or force-locked manner.

The housing 12 of the plug 11 has a few holes 18 under the pressed screen 13, as represented in FIG. 6, through which the litz wires of the line 14 can be routed in order to reach the plug contacts 17. The holes 18 and, therefore, the plug contacts 17, are on the same circumferential path, however, i.e., are situated equally far away from the center of the electrical central release device 2 as viewed in the radial direction. Three domes 16 are utilized, wherein one dome 16 conceals the three female plug contacts 17 for the stator 4, while two domes 16 accommodate three male plug contacts 17 in one case and, in the other case, four male plug contacts for the sensor 5. All the domes 16 are surrounded by seals 15.

Referring back to FIG. 2, it is also noted that the plug contacts 17 extend through the recess 9. A material-reduction area 19 is also formed around the recess 9 by the carrier 3.

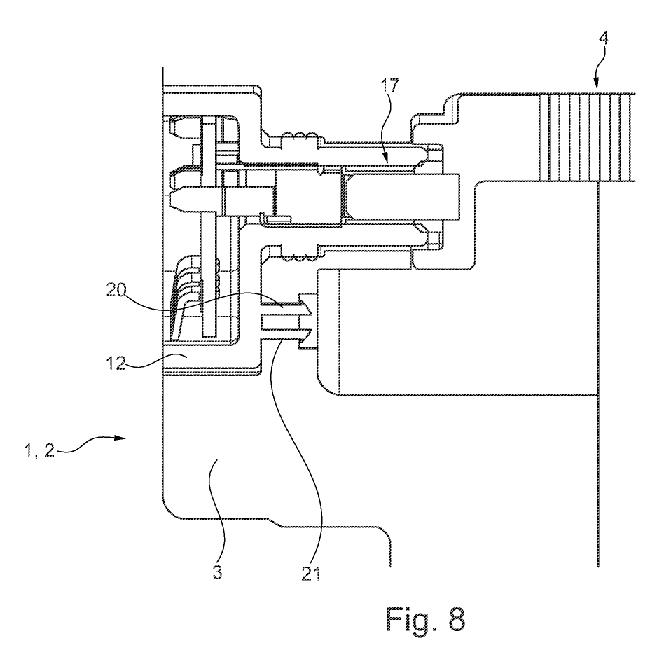

As is also clear from FIG. 8, the housing 12 also includes a fastening projection 20 which is formed separately from the plug contacts 17, in particular as a compressible pin, in order to be inserted, in an interlocking manner, in a through-hole 21 as a type of fastening recess.

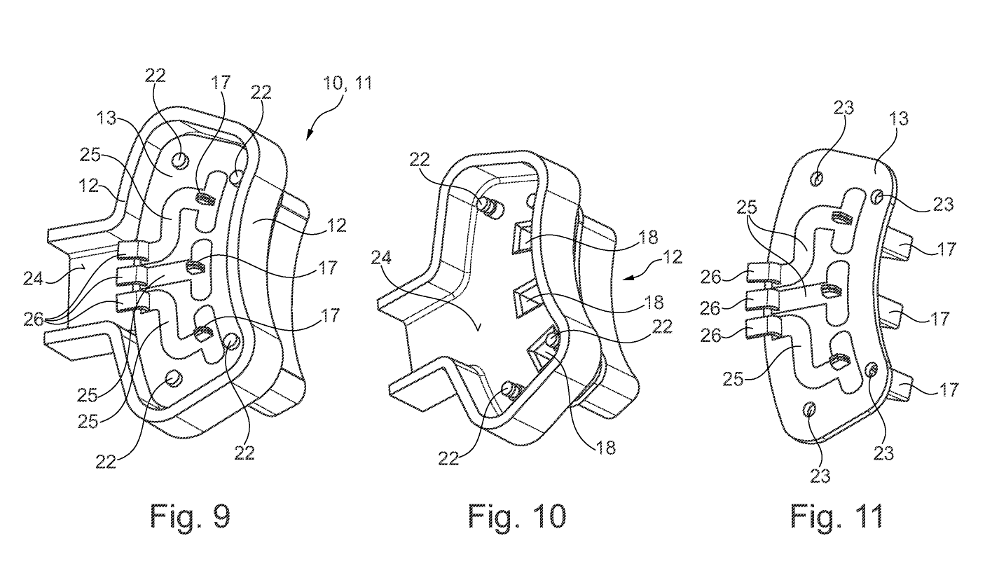

A further exemplary embodiment is represented in FIGS. 9 to 11. The plug 11 includes multiple pins 22 on the housing 12, which engage into form-fit openings 23. The pins 22 and the form-fit openings 23 are matched to each other in such a way that, on the one hand, a fastening of the pressed screen 13 on the housing 12 is achieved and, on the other hand, a predetermined spacing from a base of the plug 24 is simultaneously predetermined. The base is labeled with the reference number 24 (see FIG. 10). Current-conducting tracks 25 are provided between the plug contacts 17 and the connection elements 26.

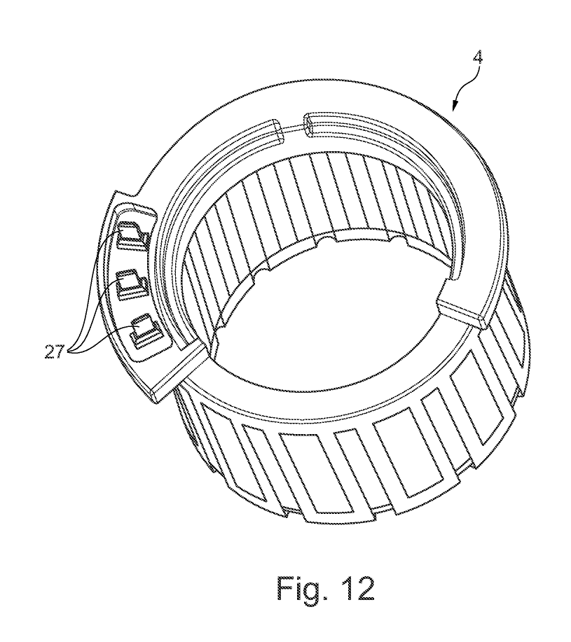

The stator 4 is also represented in greater detail in FIG. 12 and includes contact points 27. These contact points 27 are provided for connection to the plug contacts 17.

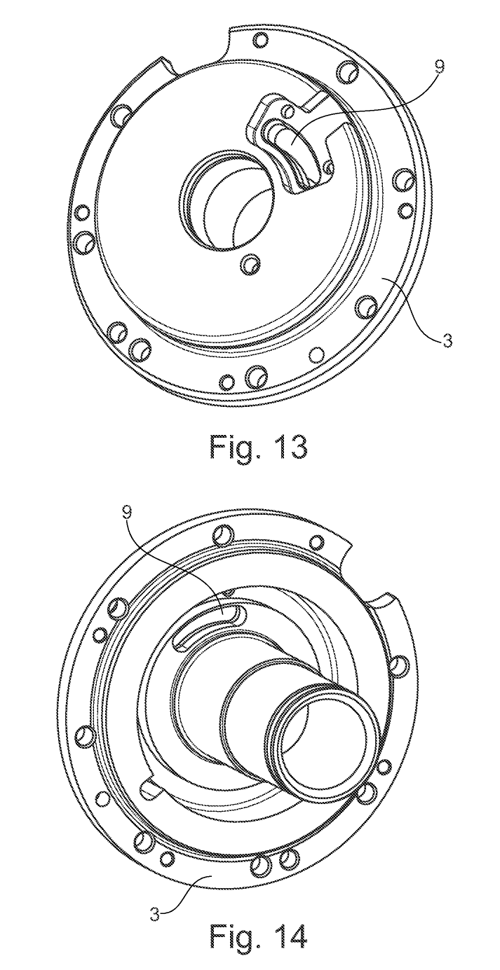

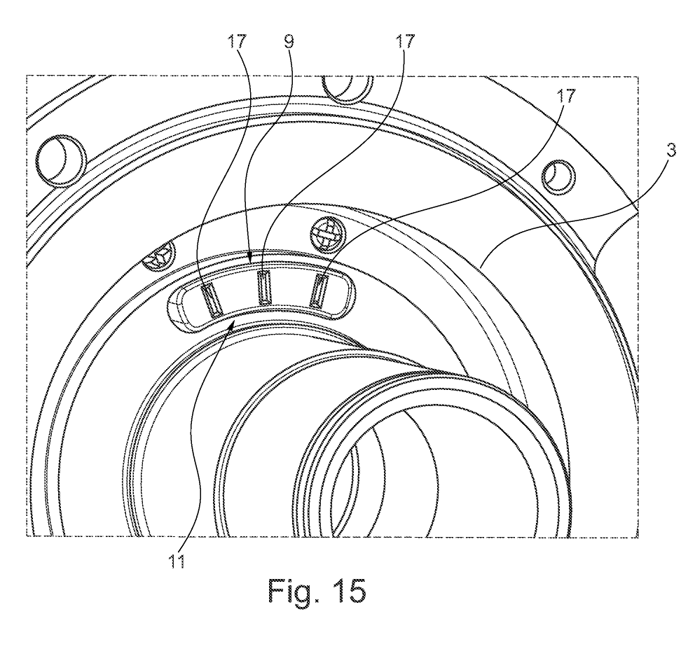

The slot-like/elongate design of the recess 9 is also clear from the representation of the next exemplary embodiment from FIGS. 13 to 15. The inserted state of the plug contacts 17 into the recess 9 is illustrated in FIG. 15; as a result thereof, the plug 11 is integrated into the carrier 3.

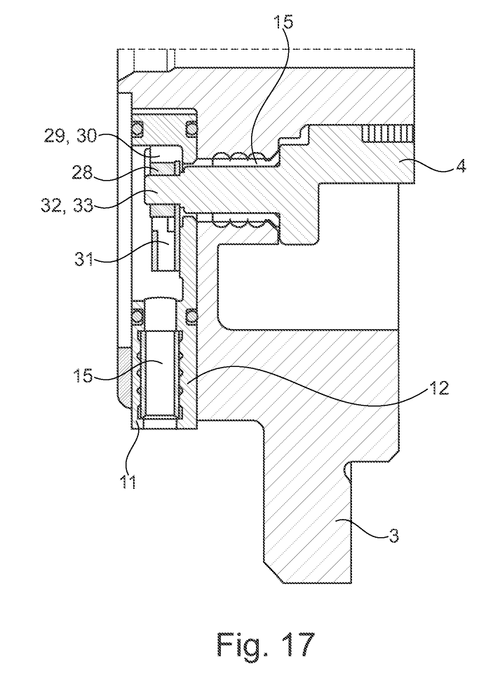

FIG. 16 shows another possible variant embodiment of the plug 11, in the form of screw-held contacts. The plug 11 is interlockingly inserted into the carrier 3, as described above with reference to preceding exemplary embodiments. The screwing-down of the contacts takes place with the aid of nuts 28 and is comparable to a terminal block (see FIG. 17).

FIG. 17 shows a sectional representation through the carrier 3 from FIG. 16, which extends through one of the screw-held contacts. By way of this sectional view, it is clear to see how the contact is implemented between the stator 4 and a contacting pin 29 or litz wire 30 of a cable 31. The stator 4, which is partially located in the carrier 3, has a cylindrical, distal end 32 including a thread, and a stator pin 33 which extends through the plug housing 12 into the plug 11.

The cable 31 extends perpendicularly to the longitudinal direction of the distal end 31 of the stator 4 and through the plug 11 and touches the stator pin 33 by way of its litz wire 30. The litz wire 30 is placed around the stator pin 33, for example, in the shape of a hook, a loop, or an “L” in this case. A nut 28 is subsequently screwed onto the thread of the stator pin 33 in order to fix this contact in position.

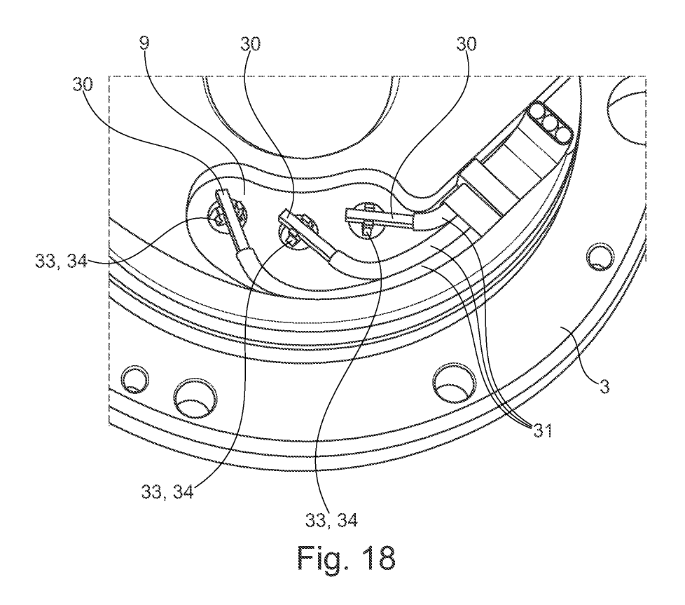

One variant of the carrier 3 without the plug 11 is represented, as a cutout, in FIG. 18. In this case, the litz wires 30 of the cables 31 are welded onto the stator pins 33. In this case, the stator pins 33 have, for example, fork-like shapes (fork 34) into which the litz wires 30 (used as contacting pin 29) are placed, inserted, and/or slid and are subsequently welded to the stator pins 33 (the forks 34), for example by means of resistance welding. Subsequently, the indentation/recess 9 is completely filled/cast with sealing compound (not shown), thereby insulating the welded contacts between the particular contacting pins 29 or the litz wires 30 and the forks 34.

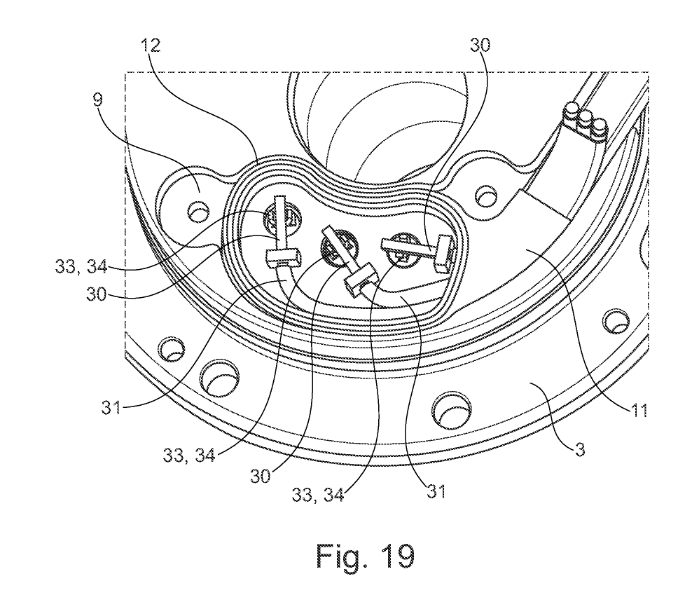

FIG. 19 shows a cutout representation of the carrier 3 in a variant including a plug 11 and welded contacts between the litz wires 30 of the cables 31 and fork-shaped stator pins 33. The plug 11 is interlockingly inserted into the recess 9 of the carrier 3 provided therefor. In contrast to the variant described in FIG. 18, the welded contacts are exposed in this case.

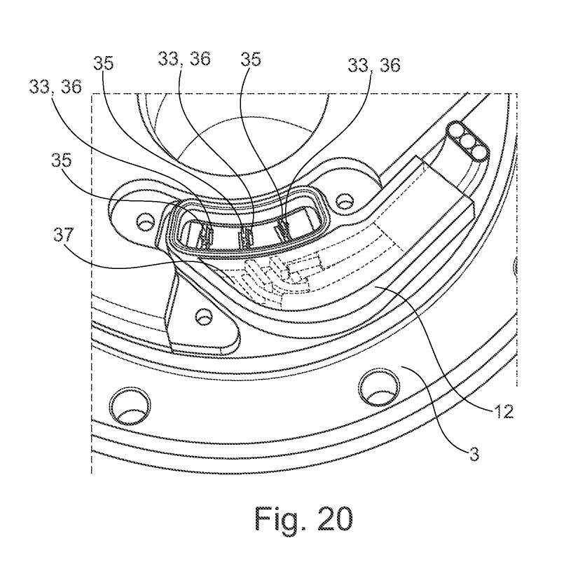

FIG. 20 also shows an exemplary embodiment including a plug 11, which has been inserted into the carrier 3, and welded contacts. In this embodiment, the contact between the litz wire 30 or the cable 31 and the stator pin 33 is implemented via an intermediate part 35. In this case, the intermediate part is connected to the plug 11 and is resistance-welded to the stator pin 33 which is designed in the form of a pin 36 in this case. The contact between the intermediate part 35 and the litz wires 30 is located within or underneath the plug 11 and is not apparent in this Figure.

In this exemplary embodiment, the plug 11 is divided via the plug housing 12 into two areas. A first area surrounds the welded contacts and a second area accommodates the cables 31 and simultaneously functions as a guide therefor. The second area, through which the cables 31 extend, is filled with a sealing compound 37. The first area, in which the welded contacts are located, remains untouched by the sealing compound 37, so that the contacts are exposed. Said area is subsequently closed with a cover (not shown here).

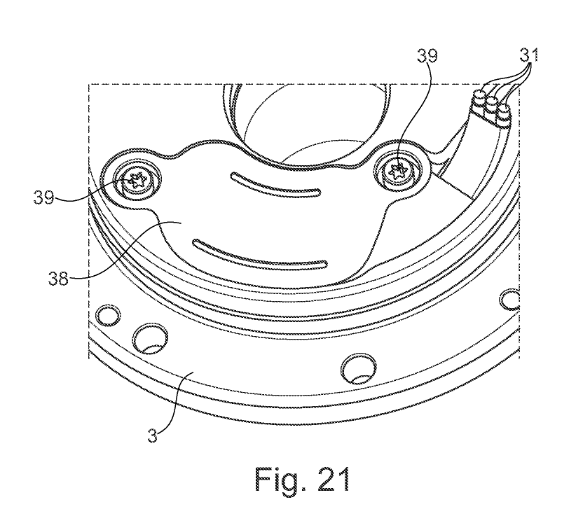

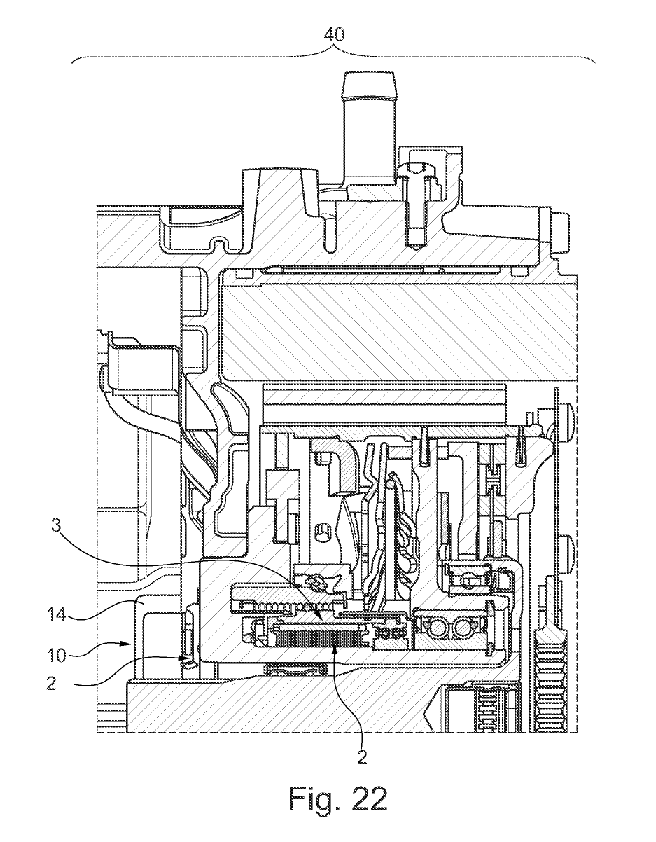

FIG. 21 shows a cutout representation of the carrier 3 including an exemplary embodiment of a cover 38. The cover 38 is screwed on the carrier 3, for example by means of screws 39, and covers the area of the recess 9 in the carrier 3 in an interlocking manner and so as to be flush with the carrier surface. The cover 38 prevents penetration by dirt particles and/or fluids, such as, for example, oil or water, and therefore protects the contacts lying thereunder with the aid of a seal (not shown) which is pressed by the cover 38 onto the housing 12.

In addition, the cover 38 can be used for clamping the plug, including the contacts, between itself and the carrier 3 or the plug housing 12 and therefore reduce the tensile load, which acts on the weld seams of these contacts, particularly in the case of the welded contacts.

A hybrid module 40 according to the present disclosure is represented in FIG. 22. An actuator 1 according to the present disclosure, which is designed as a type of electrical central release device 2, is inserted into this hybrid module 40. The area of the leadthrough of the signal transmission and/or power supply element 10 is not present in the longitudinal sectional plane.

### LIST OF REFERENCE NUMBERS

1 actuator

2 electrical central release device

3 carrier

4 stator

5 sensor

6 rotor

7 adjusting sleeve

8 support bearing

9 recess

10 signal transmission and/or power supply element

11 plug

12 housing of the plug

13 pressed screen/circuit board

14 line

15 seal

16 dome

17 plug contact

18 hole

19 material-reduction area

20 fastening projection

21 through-hole

22 pin

23 form-fit opening

24 base

25 conductive track

26 connection element

27 contact point

28 nut

29 contacting pin

30 litz wire

31 cable

32 distal end of the stator

33 stator pin

34 fork

35 intermediate part

36 pin

37 sealing compound

38 cover

39 screw

40 hybrid module

1.-10. (canceled)

11. A motor vehicle clutch actuator, comprising:
a carrier including at least one recess; and,
a signal transmission element integrated into the carrier and routed through the carrier for transmitting a signal to a stator; or,
a power supply element integrated into the carrier and routed through the carrier for transmitting a power supply to the stator.

12. The actuator of claim 11 further comprising:
a sensor supported by the carrier; and,
the stator, wherein the stator is supported by the carrier.

13. The actuator of claim 12, wherein the stator includes a carrier-side distal end with a fork-like shape or a pin-like shape.

14. The actuator of claim 12, further comprising an electrical contact element, wherein:
the stator includes a carrier-side distal end for holding the electrical contact element; and,
the electrical contact element is connectable to a litz wire of a cable.

15. The actuator of claim 14, wherein: the electrical contact element is a sleeve, a bushing, a clamp, a crimping unit, or an overshoe.

16. The actuator of claim 14 wherein the carrier-side distal end includes a thread and a nut, the nut supporting the electrical contact element in a certain position relative to the carrier or the stator.

17. The actuator of claim 14, wherein the carrier-side distal end has a fork-like shape or a pin-like shape.

18. The actuator of claim 17, wherein the litz wire is welded to a tine of the fork-like shape or a pin of the pin-like shape.

19. The actuator of claim 17 wherein a contacting intermediate part is installed on a tine of the fork-like shape or a pin of the pin-like shape.

20. The actuator of claim 11 wherein:
the signal transmission element or the power supply element comprises individual contact elements inserted into the carrier.

21. The actuator of claim 11 wherein:
the signal transmission element or the power supply element is a plug, or is integrated into a plug.

22. The actuator claim 21 wherein the plug is closed by a cover on the outside of the plug.

23. A hybrid module comprising:
a clutch;
the actuator of claim 11; and,
a plug inserted into the actuator.
